(19) United States
(12) Patent Application Publication
(10) Pub. No.: US 2013/0050448 A1
(43) Pub. Date: Feb. 28, 2013

(54) METHOD, CIRCUITRY AND SYSTEM FOR BETTER INTEGRATING MULTIVIEW-BASED 3D DISPLAY TECHNOLOGY WITH THE HUMAN VISUAL SYSTEM

(71) Applicant: Philip L. Swan, Richmond Hill (CA)

(72) Inventor: Philip L. Swan, Richmond Hill (CA)

(73) Assignee: ATI Technologies ULC, Markham (CA)

(21) Appl. No.: 13/216,765

(22) Filed: Aug. 24, 2011

(51) Int. Cl. H04N 13/04

(52) U.S. Cl. 348/54; 348/E13.075

(57) ABSTRACT

Circuitry for better integrating multiview-based 3D display technology with the human visual system includes logic that identifies an object of interest from a plurality of objects in a multiview-based 3D scene displayed on one or more displays and provides focus adjustment control data for eyewear to view the 3D scene based on perceived distance data corresponding to the identified at least one object of interest and the identified at least one object of interest. In one example, the circuitry includes logic that determines the perceived distance data corresponding to the at least one object of interest based on inter-object distance data indicating a horizontal offset between the at least one object of interest in a first scene view and the same at least one object of interest in a second scene view and display distance data indicating the distance between one or more display screens and a viewing position. Related methods are also set forth.

### FIELD OF THE DISCLOSURE

The present disclosure relates generally to three-dimensional (“3D”) imaging systems that present 3D images on a display screen and, more specifically, to a method, circuitry and a system for better integrating multiview-based 3D display technology with the human visual system.

### BACKGROUND OF THE DISCLOSURE

Stereoscopic imaging (i.e., 3D imaging) is a technique designed to enhance the perception of depth in an image by providing the eyes of a viewer with two different images, representing two different views (i.e., perspectives) of the same object(s). This technique has become an increasingly popular mechanism for displaying video and movies as it provides the viewer with a heightened sense of reality.

Conventional 3D imaging systems often provide two two-dimensional (“2D”) images representing two different views of a scene (i.e., a stereoscopic pair). For example, one image may be provided for the left eye while a different image is provided for the right eye. A viewer's brain fuses the two 2D images together thereby creating the illusion of depth in the multiview-based 3D scene comprised of the two images. In one example, the different images are provided sequentially (e.g., in an alternating sequence of left eye image, right eye image, left eye image, etc.) at a rate of, for example, 30 Hz. In another example, the two images are superimposed on a display simultaneously through different polarizing filters.

Existing 3D imaging systems regularly employ specialized eyewear, such as glasses, designed to complement the method in which the different 2D images are displayed. For example, where the 2D images are provided sequentially, conventional 3D systems are known to employ eyewear having a shutter mechanism that blocks light in each appropriate eye when the converse eye's image is displayed on a display screen. Where the 2D images are superimposed on a display simultaneously, conventional systems often employ, for example, eyewear containing a pair of polarizing filters oriented differently (e.g., clockwise/counterclockwise or vertical/horizontal). Each filter will only pass light through that is similarly polarized and blocks light that is polarized differently. In this manner, each eye views the same scene from a slightly different perspective, providing for the 3D effect.

Human vision uses several cues to determine relative depths in a perceived scene. For example, the aforementioned techniques rely on the human vision cue of stereopsis. That is to say, the aforementioned techniques create the illusion of depth in an image by allowing an object in an image to be viewed from multiple perspectives. However, these techniques fail to account for additional vision cues, such as accommodation of the eyeball (i.e., focus).

Accommodation is the process by which the vertebrate eye changes optical power to maintain a clear image (focus) on an object as the distance between the object and the eye changes. As the eye focuses on one object, other objects become defocused. Because conventional 3D imaging systems fail to account for the human vision cue of accommodation, a viewer viewing a 3D scene displayed using a conventional 3D imaging system will perceive all of the objects in a 3D scene as being in focus. This has the effect of confusing a viewer's brain as it attempts to reconcile the two conflicting vision cues of stereopsis and accommodation. Stated another way, a viewer's brain becomes confused as to why objects that are not being focused on are nonetheless in focus (i.e., clear). In general confusion of this kind is believed to be responsible for inducing nausea and other adverse effects in some viewers.

Additionally, adjustable focus eyewear is known to exist. For example, U.S. Pat. Nos. 7,325,922 and 7,338,159 to Spivey disclose adjustable focus eyeglasses and adjustable focus lenses, respectively. These patents describe eyewear capable of being mechanically adjusted to change the focusing power of the lens unit. As such, a wearer of these glasses can adjust their focus to provide for a clearer view of the object that they are looking at.

Accordingly, a need exists for a 3D imaging system that accounts for vision cues other than stereopsis in order to provide for a more realistic and enjoyable viewing experience.

### BRIEF DESCRIPTION OF THE DRAWINGS

The disclosure will be more readily understood in view of the following description when accompanied by the below figures and wherein like reference numerals represent like elements, wherein:

FIG. 1 is a block diagram illustrating one example of a system for adjusting the focus of lenses in eyewear in order to place an object of interest in focus.

FIG. 2 is a drawing illustrating one example of a viewer viewing a perceived object of interest using the system for adjusting the focus of lenses in eyewear in order to place the perceived object of interest in focus.

FIG. 3 is a drawing illustrating one example of eyewear used in the system for adjusting the focus of lenses in eyewear in order to place the object of interest in focus.

FIG. 4 is a drawing illustrating one example of a multiview-based 3D scene.

FIG. 5 is a flowchart illustrating one example of a method for providing focus adjustment control data.

FIG. 6 is a flowchart illustrating another example of a method for providing focus adjustment control data.

FIG. 7 is a flowchart illustrating one example of a method for blurring objects in a multiview-based 3D scene.

### SUMMARY OF THE EMBODIMENTS

Briefly, the present disclosure provides methods, circuitry and a system for better integrating multiview-based 3D display technology with the human visual system. In one example, a method for better integrating multiview-based 3D display technology with the human visual system is disclosed. In this example, the method includes identifying at least one object of interest from a plurality of objects in a multiview-based 3D scene displayed on one or more displays. Focus adjustment control data may be provided for eyewear in order to view the 3D scene, wherein the focus adjustment control data is based on perceived distance data corresponding to the identified at least one object of interest and the identified at least one object of interest.

In one example of the above method, the perceived distance data corresponding to the identified at least one object of interest is determined based on inter-object distance data indicating a horizontal offset between the at least one object of interest in a first scene view and the same at least one object of interest in a second scene view and display distance data. In one example, the display distance data includes data indicating the distance between the one or more display screens and a viewing position. In one example, the first scene view and the second scene view comprise at least one of a left eye image and a right eye image.

In another example, identifying the at least one object of interest from the plurality of objects in the multiview-based 3D scene is accomplished by monitoring viewing direction data indicating a viewing direction of at least one eyeball viewing the 3D scene through the eyewear. In another example, the at least one object of interest is identified by analyzing test audience viewing direction data indicating a viewing direction of a test audience when the test audience viewed the 3D scene. In yet another example, the at least one object of interest is identified by evaluating each object's proximity from the center of the 3D scene. In another example, the at least one object of interest is identified by evaluating the size of each object in relation to the size of the 3D scene.

In another example, the method includes adjusting a focus of at least one lens in the eyewear to place the at least one object of interest in focus in response to the provided focus adjustment control data. In yet another example, the method includes comparing pixels in a first scene view with pixels in a second scene view to identify which at least one object in the first scene view is the same at least one object in the second scene view to provide objection correlation data.

In still another example, the method includes determining a perceived distance between the at least one object of interest and at least one other object. In this example, a level of blurring is applied to each at least one other object where the specific level of blurring that is applied is based on the perceived distance between the at least one object of interest and the at least one other object.

Circuitry in accordance with the present disclosure includes logic operative to carry out the above method.

A system in accordance with the present disclosure includes an apparatus having circuitry operative to identify at least one object of interest from a plurality of objects in a multiview-based 3D scene. The circuitry of the apparatus is also operative to provide focus adjustment control data for eyewear to view the 3D scene based on perceived distance data corresponding to the identified at least one object of interest and the identified at least one object of interest. Additionally, the circuitry is operative to determine a perceived distance between the at least one object of interest and at least one other object. The circuitry is also operative to apply a level of blurring to each at least one other object, wherein the level of blurring is based on the perceived distance between the at least one object of interest and the at least one other object.

In one example, the system includes one or more displays operative to output the multiview-based 3D scene. In another example, the system includes eyewear operatively connected to the apparatus, the eyewear operative to adjust a focus of at least one lens in the eyewear in response to the provided focus adjustment control data. In one example, the eyewear includes a range finder operative to provide display distance data indicating the distance between the one or more display screens and a viewing position, such as the location of a person viewing the 3D scene.

Eyewear in accordance with the present disclosure is also disclosed. In one example, the eyewear includes an adaptive lens configuration operative to adjust a focus of at least one lens in the eyewear in response to receiving focus adjustment control data. In this example, the eyewear also includes a range finder comprising a transmitter and a receiver. Continuing with this example, the range finder is operative to provide display distance data indicating the distance between one or more display screens and a position of the eyewear. In one example, the eyewear also includes a viewing direction detector operative to detect a viewing direction of at least one eyeball to provide viewing direction data. The range finder may also be mounted on the display or may have components mounted on both the display and the eyewear.

Among other advantages, the disclosed method, circuitry and system account for the human vision cue of accommodation in order to improve a user's viewing experience when viewing a multiview-based 3D scene. Specifically, the disclosed method, circuitry and system account for the vision cue of accommodation by allowing for the adjustment of the focus of lenses in eyewear. Allowing for the adjustment of the focus of lenses in eyewear used to view a multiview-based 3D scene reduces and/or eliminates entirely the possibility of a viewer receiving conflicting vision cues with regard to stereopsis and accommodation. This in turn reduces the likelihood of a viewer experiencing nausea or other undesirable side effects that are possibly associated with prior art 3D imaging systems. Other advantages will be recognized by those of ordinary skill in the art.

### DETAILED DESCRIPTION OF THE PREFERRED EMBODIMENTS

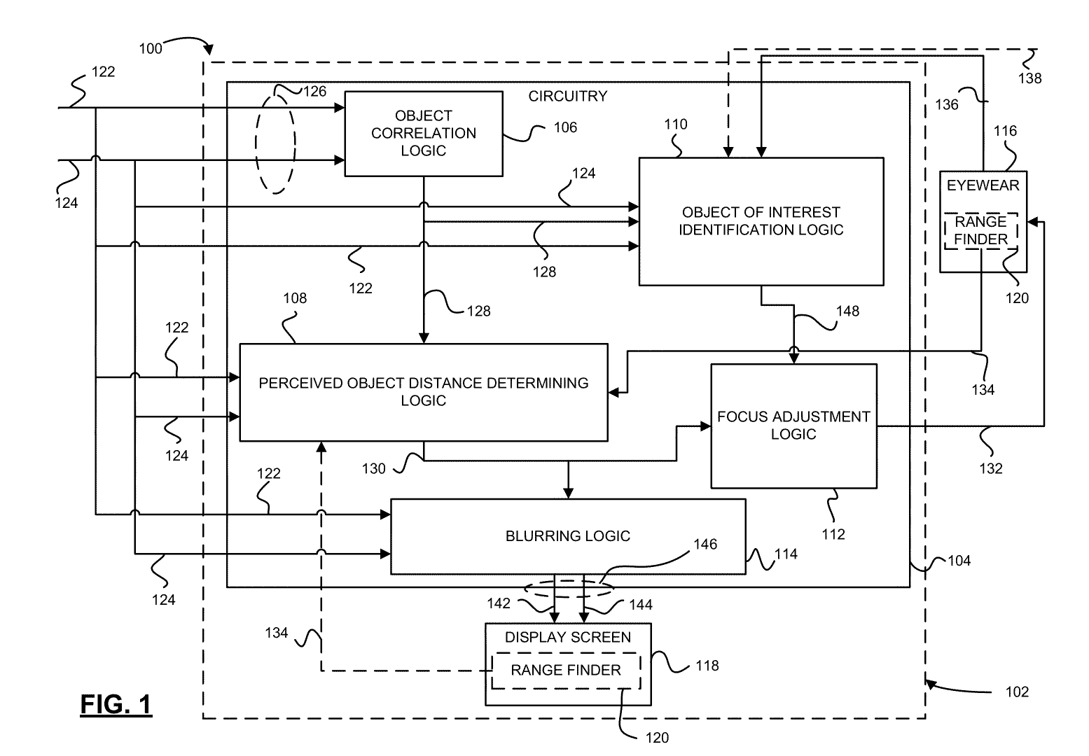

The following description of the embodiments is merely exemplary in nature and is in no way intended to limit the disclosure, its application, or uses. FIG. 1 illustrates one example of a system 100. The system 100 is generally comprised of circuitry 104 and eyewear 116. The circuitry 104 may comprise, for example, one or more processors (e.g., shared, dedicated, or group of processors such as but not limited to microprocessors, digital signal processors, or central processing units) and memory that execute one or more software or firmware programs, combinational logic circuits, an application specific integrated circuit, and/or other suitable components that provide the described functionality. In one example, the circuitry 104 is contained in an apparatus 102 having a display screen 118, such as, for example, a cathode-ray tube (CRT) display, liquid crystal display (LCD), light-emitting diode (LED) display, plasma display, digital light processing (DLP) display, or any other suitable apparatus known in the art. The apparatus 102 may also comprise, for example, a laptop computer, personal digital assistant (PDA), cellular telephone, tablet (e.g., an Apple® iPad®), or any other suitable apparatus having a display screen 118.

Circuitry 104 includes object correlation logic 106 operatively connected to perceived object distance determining logic 108 and object of interest identification logic 110 over a suitable communication channel such as a bus. As used herein, “logic” may comprise any suitable hardware, firmware, or combination of executing software and digital processing circuits capable of achieving the described functionality. Perceived object distance determining logic 108 is additionally operatively connected to focus adjustment logic 112, blurring logic 114, and eyewear 116 over a suitable communication channel such as a bus. The focus adjustment logic 112 is also operatively connected to object of interest identification logic 110 and eyewear 116 over a suitable communication channel such as a bus.

Further, eyewear 116 is operatively connected to object of interest identification logic 110 over a suitable communication channel such as a bus. Although the preceding examples describe the eyewear 116 being connected to the circuitry elements 110, 108, and 112 over a physical communication channel such as a bus, it is appreciated that eyewear 116 could equally well be connected to the to the circuitry elements 110, 108, and 112 over a wireless communication channel (e.g., Bluetooth), as known in the art. Blurring logic 114 is operatively connected to display screen 118 over a suitable communication channel such as a bus. Although a single display screen 118 is shown, it is recognized that a plurality of display screens 118 could be equally employed. Blocks 106-114 may be, for example, integrated on one or more integrated circuit chips. Accordingly, the described functionality may be broken up as desired among one or more integrated or discrete components.

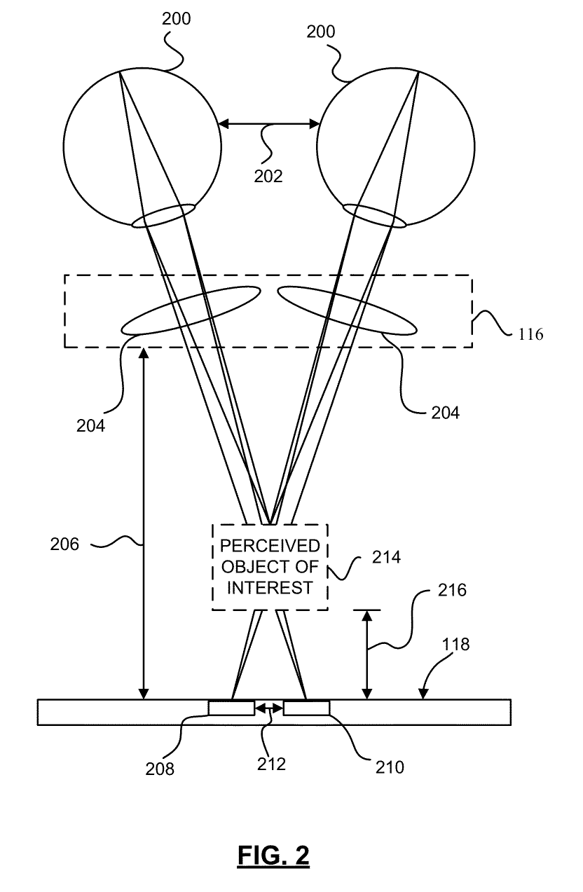

In one example, eyewear 116 includes a range finder 120. The range finder 120 includes a transmitter and a receiver, such as any suitable transmitter and receiver known in the art, and is operative to provide display distance data 134 to the perceived object distance determining logic 108. As used herein, “data” includes any analog or digital signal that represents, for example, a distance. Thus, “display distance data” comprises any analog or digital signal that represents the display distance 206 (as shown in FIG. 2) as described herein. The display distance data 134 indicates the distance between the one or more display screens 118 and a viewing position (i.e., the location of a viewer viewing the at least one display screen 118), such as a position of the eyewear 116. That is to say, the range finder 120 includes logic suitable to calculate how far the eyewear 116 (or viewer) is from the one or more display screens 116 of the apparatus 102. For example, the range finder 120 may calculate how far the eyewear 116 is from the one or more display screens 118 by using the transmitter to propagate a signal (e.g., a sound signal, radio signal, an infrared signal, etc.), using the receiver to receive the propagated signal once it has bounced off of the at least one display screen 118, and using the ranger finder's logic to determine the distance between the at least one display screen 118 and a position of the eyewear 116 (e.g., by calculating distance between the eyewear 116 and display screen(s) 118 based on propagation delay). That is to say, the ranger finder may employ techniques such as sonar, radar, infrared distance determination, or any other suitable distance determination technique known in the art to determine the distance between the eyewear 116 and the at least one display screen 118. It is equally appreciated that the range finder 120 could be included as part of the display screen 118, or the circuitry 104 for that matter. The particular implementation of the range finder 120 is immaterial provided that it is functional to provide display distance data 134 for the perceived object distance determining logic 108.

Alternatively, it is recognized that other mechanisms may be employed to determine the distance between the at least one display screen 118 and a viewing position (i.e., the location of a viewer viewing the multiview-based 3D scene on the at least one display 118). For example, it is known in the art to use machine vision techniques to determine the distance between two objects (e.g., a viewer and a display screen 118). Such a machine vision technique may include, for example, using a camera to capture images of the viewer in relation to the at least one display screen 118 and calculating the distance between the viewer and the at least one display screen 118 based on the image.

In operation, a first scene view 122 and a second scene view 124 are provided to object correlation logic 106. The first scene view 122 comprises, for example, a first image frame comprised of pixels depicting a scene from a first view (i.e., perspective). Similarly, the second scene view 124 comprises, for example, a second image frame comprised of pixels depicting the same scene from a second view. The combination of the first and second scene views 122, 124 comprises the multiview-based 3D scene 126. In one example, the first and second scene views comprise left and right eye images (i.e., a stereoscopic pair). In another example, the first and second scene views 122, 124 do not correspond to left and right eye images and are merely different views of a same scene, not taken with reference to human eyes. In any event, the first and second scene views 122, 124 include pixel data indicating, for example, YCbCr values, YUV values, YPbPr values, Y¹UV values, etc., and coordinate data (e.g., x, y, and z values) for each pixel in each scene view 122, 124.

In order to enhance the illusion of depth in the multiview-based 3D scene 126, the first and second scene views 122, 124 depict the same objects in the 3D scene 126 from different perspectives. Object correlation logic 106 is operative to determine which objects in, for example, the first scene view 122 are the same objects in the second scene view 124. Object correlation logic accomplishes this by comparing pixels in the first scene view 122 with pixels in the second scene view 124 to identify which objects(s) in the first scene view 122 are the same object(s) in the second scene view 124.

One exemplary way in which the object correlation logic 106 may identify which objects(s) in the first scene view 122 are the same object(s) in second scene view 124 is by performing a pixel matching algorithm such as, for example, sum-absolute-difference (SAD) between the pixels in the first and second scene views 122, 124. A pixel matching algorithm, such as SAD, compares pixel values, such as y-luma values, between pixels in a first scene view 122 and pixels in a second scene view 124. Where the difference between a pixel value corresponding to a pixel in the first scene view 122 and a pixel value corresponding to a pixel in the second scene view 124 is zero, the pixels are recognized as being part of the same object. The present disclosure recognizes that other algorithms could be suitably used as well, such as, for example, mean square error (MSE) or mean absolute difference (MAD), among others.

Along with determining which objects are the same between the first and second scene views 122, 124, the object correlation logic 106 is also operative to perform object segmentation in order to recognize the edges of each distinct object. Any suitable object segmentation technique known in the art may be applied to first and second scene views 122, 124 in order to distinguish between different objects in, for example, a first or second scene view 122, 124. Suitable object segmentation techniques may include, but are not limited to, for example, K-means algorithms, histogram-based algorithms, etc. Following object correlation and segmentation, object correlation logic 106 is operative to provide object correlation data 128 to perceived object distance determining logic 108 and object of interest identification logic 110. Object correlation data 128 indicates which distinct object in the first scene view 122 is the same distinct object in the second scene view 124 based on the results of the object correlation and segmentation processes.

Perceived object distance determining logic 108 accepts first and second scene views 122, 124, the object correlation data 128, and display distance data 134 as input. Perceived object distance determining logic 108 is operative to determine the perceived distance of each object in the multiview-based 3D scene based on inputs 122, 124, 128, and 134. As used herein, perceived object distance refers to the distance between the front of the at least one display screen 118 and the perceived location of a 3D object from the viewer's perspective. That is to say, while each object is actually rendered on the display screen 118, many objects appear to be either in front of the at least one display screen 118 or behind the at least one display screen 118 because of the 3D effect created by providing different perspective views (i.e., the first and second scene views 122, 124) to the viewer.

For example, with brief reference to FIG. 2, perceived object distance 216 is indicative of the perceived distance between the display screen 118 and the perceived object of interest 214. While perceived object distance 216 is shown from the front of the display screen 118 to the back (from the viewer's perspective) of the perceived object of interest 214, it is recognized that this distance 216 could equally be taken from the front of the display screen 118 to any suitable location on a perceived object. In order to determine the perceived distance of each object in the 3D scene, the perceived object distance determining logic 108 first determines an inter-object distance (e.g., distance 212) indicating a horizontal offset between an object (e.g., object 208) in the first scene view 122 and the same object (e.g., object 210) in the second scene view 124. The perceived object distance determining logic 108 analyzes the object correlation data 128 indicating which objects are the same between the first and second scene views 122, 124. The perceived object distance determining logic 108 is then operative to use the coordinate data corresponding to the pixels making up the first and second scene views 122, 124 in order to determine the inter-object distance between like objects in the different scene views 122, 124.

Perceived object distance determining logic 108 is then operative to determine the perceived distance of each object in the 3D scene based on an inter-object distance corresponding to a given object and the display distance data 134 indicating the distance 206 between the at least one display screen 118 and a viewing position using techniques known in the art. The viewing position may be, for example, the position of the eyewear 116. Accordingly, the perceived object distance determining logic 108 is operative to provide perceived object distance data 130 (including perceived object of interest distance data) to blurring logic 114 and focus adjustment logic 112.

Object of interest identification logic 110 is operative to identify at least one object of interest from a plurality of objects in a multiview-based 3D scene 126 displayed on one or more displays, such as the at least one display screen 118 of apparatus 102. As used herein, an object of interest refers to at least one object within a 3D scene 126 that a viewer is inclined to focus on. Object of interest identification logic 110 may utilize a variety of techniques to identify which at least one object of interest that a viewer is likely to focus on.

For example, in one embodiment, object of interest identification logic 110 identifies at least one object of interest based on provided test audience viewing direction data 138. The test audience viewing direction data 138 indicates, for example, the viewing direction of a test audience when the test audience viewed the 3D scene 126 comprised of the first and second scene views 122, 124. This data 138 may be obtained, for example, by monitoring the viewing direction of each test audience member using sensors operative to measure the position of each audience member's irises, the size of each audience member's irises, and the focus distance of each audience member's eye's lenses as known in the art. The viewing direction of the audience members may be achieved using suitable eye-tracking techniques known in the art. For example, suitable eye-tracking techniques are disclosed in U.S. Pat. No. 7,391,887, filed Feb. 27, 2003 entitled “Eye Tracking Systems,” U.S. Pat. No. 6,926,429, filed Jan. 30, 2002 entitled “Eye Tracking/HUD System” and U.S. Pat. No. 6,394,602, filed Dec. 14, 2000 entitled “Eye Tracking System.” These patents are hereby incorporated by reference herein in their entirety.

The test audience viewing direction data 138 may be obtained, for example, based on a single test audience viewing member or several test audience viewing members (e.g., by averaging the individual test audience member's results). Using the provided object correlation data 128 and test audience viewing direction data 138, the object of interest identification logic 110 is operative to determine which same at least one object from the first and second scene views 122, 124 is the at least one object of interest. That is to say, the object of interest identification logic 110 uses the test audience viewing direction data 138 (along with the object correlation data 128 indicating which objects are the same between the first and second scene views 122, 124) to determine which object in the first and second scene views 122, 124 that the test audience was focusing on in order to provide at least one object of interest 148 to the focus adjustment logic 112.

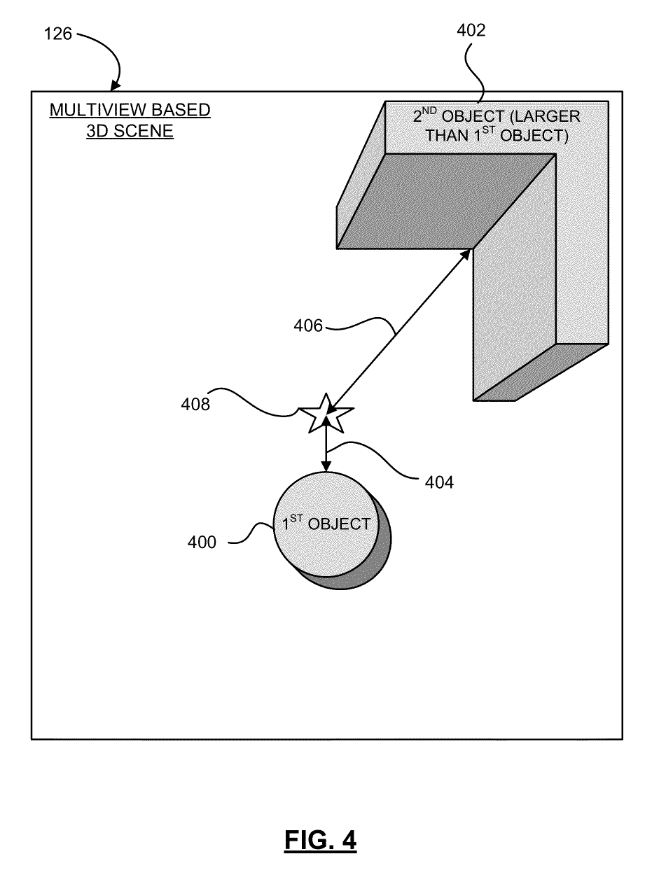

In another example, the object of interest identification logic 110 identifies at least one object of interest based on each object's proximity from the center of the 3D scene 126. This technique for identifying the at least one object of interest is best illustrated with reference to FIG. 4. FIG. 4 illustrates a multiview-based 3D scene 126 containing a plurality of objects, such as first object 400 and second object 402. In FIG. 4, arrow 406 represents the second object's proximity to the center of the 3D scene 408. Similarly, arrow 404 represents the first object's proximity to the center of the 3D scene 408. In the example illustrated in FIG. 4, the object of interest identification logic 110 would be more inclined to identify the first object 400 as the object of interest because it is closer to the center of the 3D scene than the second object 402. This technique for determining an object of interest relies on the understanding that important objects are regularly positioned near the center of a scene, such as 3D scene 126. Object of interest identification logic 110 is aware of each object's location within the 3D scene 126 based on the object correlation data 128 and the coordinate data for each pixel in each object contained within the first and second scene views 122, 124.

In another example, and with continued reference to FIG. 4, the object of interest identification logic 110 identifies at least one object of interest based on each object's size in relation to the size of the 3D scene 126. As shown in FIG. 4, the second object 402 has a greater size than the first object 400. Accordingly, in this example, the object of interest identification logic 110 would be more inclined to identify the second object 402 as the object of interest because it is larger than the first object 400. This technique relies on the understanding that important objects are often larger in size than less important ones. The object of interest identification logic 110 is aware of each object's size relative to the 3D scene 126 based on the object correlation data 128 and the coordinate data for each pixel in each object contained within the first and second scene views 122, 124.

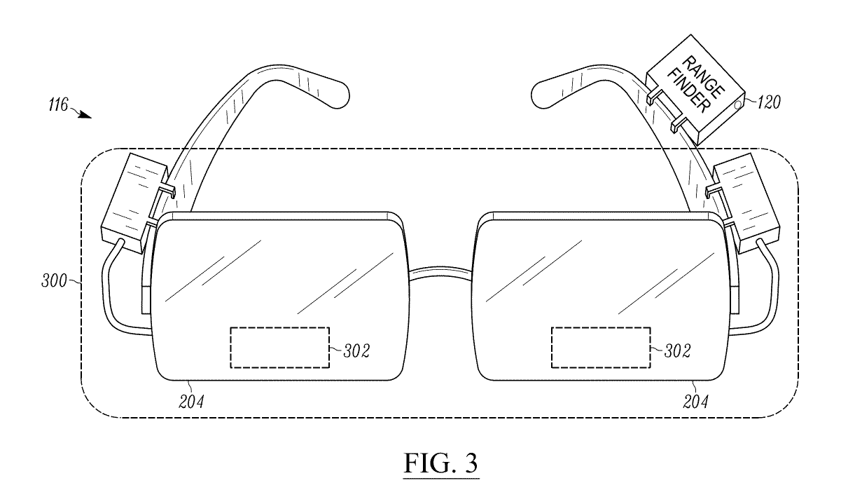

In still another example, the object of interest identification logic 110 identifies the at least one object of interest from a plurality of objects in the 3D scene 126 by monitoring viewing direction data 136 indicating a viewing direction of at least one eyeball viewing the 3D scene 126 through the eyewear 116. This technique for identifying the at least one object of interest is best illustrated with reference to FIG. 3. FIG. 3 illustrates an example where eyewear 116 includes viewing direction detectors 302. In this example, the viewing direction detectors 302 may comprise, for example, sensors capable of measuring the position of a viewer's irises, the size of a viewer's irises, and a focus distance of a viewer's eye's lenses. This position, size, and focus distance data may be used to provide the viewing direction data 136 indicating the viewing direction of a viewer's eyeball(s), as the viewer views the 3D scene 126 through the eyewear 116. As with the test audience viewing direction data 138, the object of interest identification logic 110 uses the viewing direction data 136 (along with the object correlation data 128 indicating which objects are the same between the first and second scene views 122, 124) to determine which object in the first and second scene views 122, 124 that the viewer is focusing on in order to provide at least one object of interest 148 to the focus adjustment logic 112.

The focus adjustment logic 112 accepts the at least one object of interest 148 and the perceived object distance data 130 indicating, at least, perceived distance data corresponding to the identified at least one object of interest as input. In response to the received at least one object of interest 148 and the perceived distance data corresponding to the identified at least one object of interest 130, focus adjustment logic 112 is operative to provide focus adjustment control data 132 for the eyewear 116 to view the 3D scene 126. Specifically, the object of interest 148 instructs focus adjustment logic 112 as to which object in the 3D scene 126 a viewer wearing the eyewear is focusing on (or likely to focus on). The perceived object distance data corresponding to the identified at least one object of interest 130 instructs focus adjustment logic 112 as to the perceived distance of the at least one object of interest (e.g., distance 216) from a viewer's perspective. Focus adjustment logic 112 then provides focus adjustment control data 132 to the eyewear, which instructs the eyewear 116 how to adjust the focus of lenses in the eyewear 116 such that the at least one object of interest appears in focus to the viewer. That is to say, the focus adjustment control data 132 is operative to instruct the eyewear 116 how to modify the focus of the lenses in the eyewear 116 to ensure that the object of interest is in focus. Of course, in some instances, the object of interest will not move between successive image frames, in which case the focus adjustment control data 132 will remain consistent until the object of interest moves.

Blurring logic 114 accepts perceived object distance data 130 indicating the perceived distance of each object in the 3D scene 126 (including the at least one object of interest) and the first and second scene views 122, 124 as input. Blurring logic 114 is then operative to determine a perceived distance between the at least one object of interest and the other objects in the 3D scene 126 based on the perceived object distance data 130. For example, the perceived object distance data 130 includes distance data corresponding to the identified at least one object of interest and distance data corresponding to the other (non-identified objects of interest) objects. Blurring logic 114 is operative to determine the perceived distance between the at least one object of interest and the other objects from a viewer's perspective. Based on the perceived difference in distance between the at least one object of interest and the other objects, blurring logic 114 applies a particular level of blurring to the other objects. In one example, objects that are further away from the at least one object of interest receive more blurring than objects that are closer to the at least one object of interest. This has the effect of simulating natural human vision in which objects that are far away from a focal point appear blurrier than objects that are closer to the focal point. Blurring logic 114 utilizes techniques known in the art, such as, for example, application of a Gaussian blur to the pixels making up the objects sought to be blurred through the use of, for example, a low pass filter. Of course, other suitable blurring techniques may be equally employed.

In one example, the object of interest itself may receive a particular level of blurring. Additionally, it is recognized that any given object (including the object of interest) may receive different levels of blurring in different regions of the object (i.e., different pixels making up the same object may receive different levels of blurring). This accounts for the fact that objects in the in the 3D scene 126 are perceived as having depth. Therefore, the front of an object may be perceived as being closer to the object of interest than the back of the same object (or visa versa). Accordingly, in this example, the pixels making up the front of the object may receive a lower level of blurring than the pixels making up the back of the same object.

Nonetheless, after applying the appropriate level of blurring, blurring logic is operative to provide a blurred first scene view 142 and a blurred second scene view 144 (collectively comprising the blurred 3D scene 146) to display screen 118 for display.

FIG. 2 illustrates one example of a viewer viewing a perceived object of interest 214 using the system 100 for adjusting the focus of lenses in eyewear 116 in order to place the perceived object of interest 214 in focus. For example, FIG. 2 depicts two eyeballs 200 separated by an inter-ocular distance 202. In one example, the inter-object distance 212 described above is proportional to the inter-ocular distance 202. That is to say, in one example, the real object 208 in the first scene view 122 is separated from the same real object 210 in the second scene view 124 by an inter-object distance 212 that is proportional to the inter-ocular distance 202 between the eyeballs 200. FIG. 2 further illustrates lenses 204 of the eyewear 116 through which the 3D scene 126 is viewed. As noted above, perceived object distance 216 is indicative of the perceived distance between the display screen 118 and the perceived object of interest 214, while display distance 206 is indicative of the distance between the display screen 118 and a viewing position, such as, for example, the position of the eyewear 116.

FIG. 3 illustrates one example of eyewear 116 capable of being used in the system 100. Eyewear 116 includes an adaptive lens configuration 300 that facilitates adaptively changing the focus of lenses 204 based on focus adjustment control data 132 as described above and shown in FIG. 1. In one example, the adaptive lens configuration 300 includes mechanical means for adjusting the focus of the lenses 204 in accordance with the teachings of the U.S. Pat. Nos. 7,325,922 and 7,338,159 to Spivey, the contents of which are hereby incorporated by reference in their entirety. That is to say, in one example, a viewer may manually adjust the focus of the lenses 204 to bring the at least one object of interest into focus.

In another example, the adaptive lens configuration 300 includes viewing direction detectors 302 that are configured to detect the viewing direction of the eyeballs 200 looking through the lenses 204 as described above. In this example, the adaptive lens configuration 300 is operative to provide viewing direction data 136 to object of interest identification logic 110 based on the measurements obtained by the viewing direction detectors 302. In this manner, object of interest identification logic 110 may analyze the viewing direction data 136 to determine which object in the 3D scene 126 is the object of interest (i.e., which object in the 3D scene 126 the viewer is focusing on). This in turn allows focus adjustment logic 112 to provide focus adjustment control data 132 to the adaptive lens configuration 300 of eyewear 116, such that adaptive lens configuration 300 may adjust the focus of at least one lens 204 in the eyewear 116. The adaptive lens configuration 300 may provide the viewing direction data 136 and receive the focus adjustment control data 132 over any suitable physical or wireless communication channel (e.g., a physical bus, a Bluetooth wireless link, etc.).

The adaptive lens configuration 300 is operative to adjust the focus of the lenses 204 in the eyewear 116 using techniques known in the art. For example, one technique involves the use of liquid crystal diffractive lenses (e.g., lenses 204) capable of adaptively changing their focus based on a control signal such as, for example, focus adjustment control data 132. However, other types of lenses or other adaptive focus modification techniques may also be suitably employed. For example, U.S. Pat. Pub. No. 2006/0164593, filed Jan. 18, 2006 entitled “Adaptive Electro-Active Lens With Variable Focal Length,” the contents of which is hereby incorporated by reference in its entirety, describes one example of glasses containing a suitable adaptive lens configuration.

Additionally, FIG. 3 illustrates an example where the range finder 120 is located on the eyewear 116. Although shown as being attached to the portion of the eyewear frame that sits adjacent to the viewer's left temple, it is contemplated that the range finder 120 may be located on any portion of the eyewear 116, or as noted above, detached from the eyewear 116 entirely (e.g., the range finder 120 could be located on the display screen 118 and provide the same functionality).

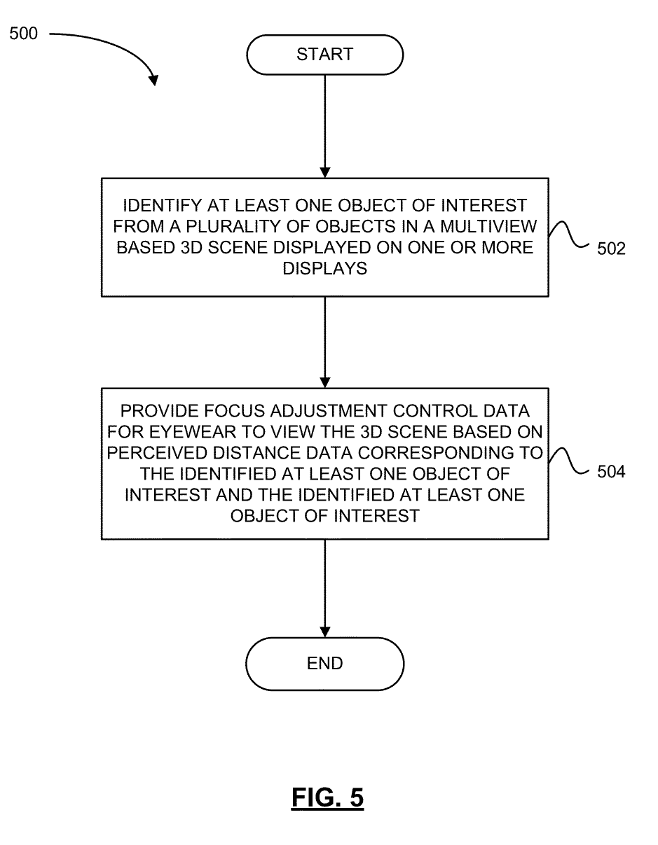

FIG. 5 illustrates one example of a method 500 in accordance with the present disclosure. The method 500 of FIG. 5 may be carried out, for example, by the circuitry 104 illustrated in FIG. 1 and described in detail above. At step 502, at least one object of interest is identified from a plurality of objects in a multiview-based 3D scene 126 displayed on one or more displays, such as display screen(s) 118. This step may be carried out by, for example, object of interest identification logic 110 in accordance with its above-described functionality. At step 504, focus adjustment control data 132 is provided for eyewear 116 to view the 3D scene 126 based on perceived object distance data corresponding to the identified at least one object of interest 130 and the identified at least one object of interest 148. This step may be accomplished, for example, by focus adjustment logic 112 as described in further detail above.

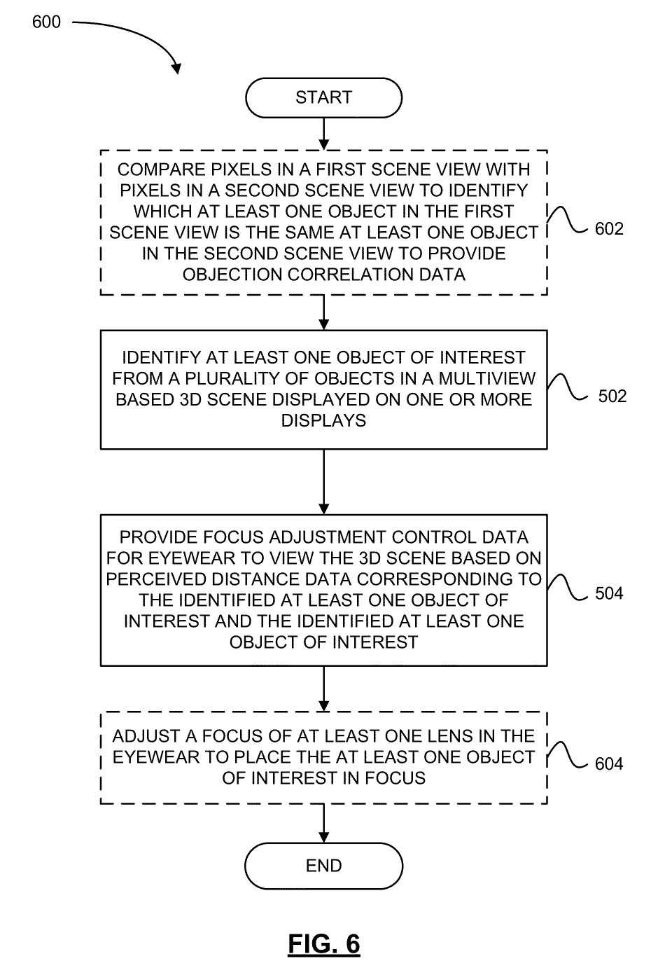

FIG. 6 illustrates another example of a method 600 in accordance with the present disclosure. The method 600 of FIG. 6 may be carried out, for example, by the circuitry 104 illustrated in FIG. 1 and described in detail above. At step 602, pixels in a first scene view 122 are compared with pixels in a second scene view 124 to identify which at least one object in the first scene view 122 is the same at least one object in the second scene view 124 to provide object correlation data 128. This step may be carried out by, for example, object correlation logic 106 in accordance with its above-described functionality. Steps 502-504 are carried out in accordance with the discussion of those steps with regard to FIG. 5. At step 604, a focus of at least one lens in the eyewear 116 is adjusted to place the at least one object of interest in focus. This step may be carried out by, for example, the adaptive lens configuration 300 of eyewear 116 in accordance with its described functionality.

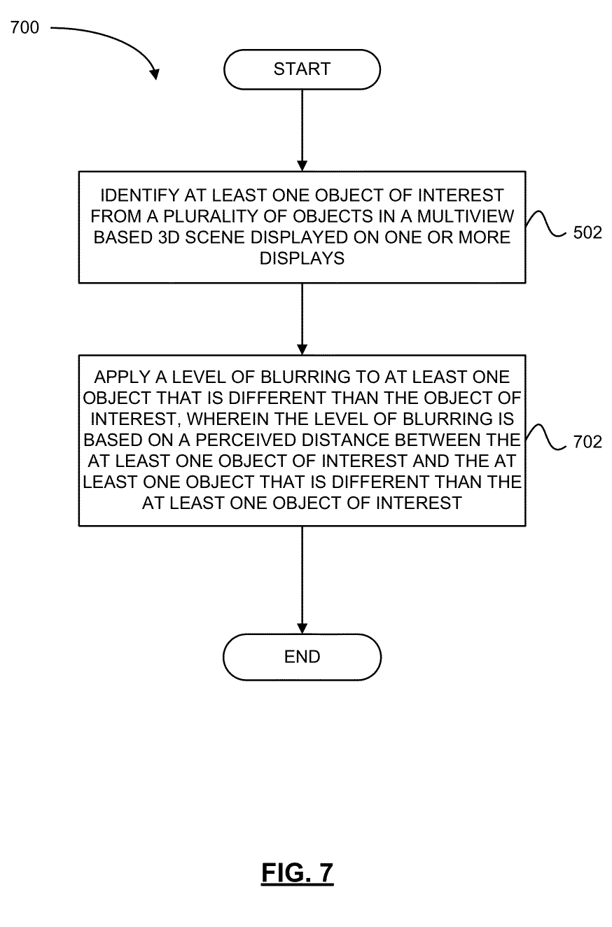

FIG. 7 illustrates another example of a method 700 in accordance with the present disclosure. The method of FIG. 7 may be carried out, for example, by the circuitry 104 illustrated in FIG. 1 and described in detail above. Step 502 is carried out in accordance with the discussion of that step with regard to FIG. 5. At step 702, a level of blurring is applied to at least one object that is different than the object of interest. The level of blurring is based on a perceived distance between the at least one object of interest and at least one object that is different than the at least one object of interest. In one example, the greater the perceived distance between a given object (i.e., an object other than the object(s) of interest) and an object of interest, the greater the level of blurring that is applied to that given object. In this manner, objects that are perceived to be further away from the object of interest will appear blurrier than the object of interest itself.

Among other advantages, the disclosed method, circuitry and system account for the human vision cue of accommodation in order to improve a user's viewing experience when viewing a multiview-based 3D scene. Specifically, the disclosed method, circuitry and system account for the vision cue of accommodation by allowing for the adjustment of the focus of lenses in eyewear. Allowing for the adjustment of the focus of lenses in eyewear used to view a multiview-based 3D scene reduces and/or eliminates entirely the possibility of a viewer receiving conflicting vision cues with regard to stereopsis and accommodation. This in turn reduces the likelihood of a viewer experiencing nausea or other undesirable side effects associated with prior art 3D imaging systems. Other advantages will be recognized by those of ordinary skill in the art.

Also, integrated circuit design systems (e.g., work stations) are known that create integrated circuits based on executable instructions stored on a computer readable memory such as but not limited to CD-ROM, RAM, other forms of ROM, hard drives, distributed memory, etc. The instructions may be represented by any suitable language such as but not limited to hardware descriptor language or other suitable language. As such, the circuitry described herein may also be produced as integrated circuits by such systems. For example an integrated circuit may be created using instructions stored on a computer readable medium that when executed cause the integrated circuit design system to create an integrated circuit that is operative to identify at least one object of interest from a plurality of objects in a multiview-based 3D scene displayed on one or more displays and provide focus adjustment control data for eyewear to view the 3D scene based on perceived distance data corresponding to the identified at least one object of interest and the identified at least one object of interest.

The above detailed description and the examples described therein have been presented for the purposes of illustration and description only and not by limitation. It is therefore contemplated that the present disclosure cover any and all modifications, variations or equivalents that fall within the spirit and scope of the basic underlying principles disclosed above and claimed herein.

What is claimed is:

1. A method comprising:
identifying at least one object of interest from a plurality of objects in a multiview-based 3D scene displayed on one or more displays; and
providing focus adjustment control data for eyewear to view the 3D scene based on perceived distance data corresponding to the identified at least one object of interest and the identified at least one object of interest.

2. The method of claim 1, wherein the perceived distance data corresponding to the identified at least one object of interest is determined based on:
inter-object distance data indicating a horizontal offset between the at least one object of interest in a first scene view and the same at least one object of interest in a second scene view and display distance data.

3. The method of claim 2, wherein the display distance data comprises data indicating the distance between the one or more display screens and a viewing position.

4. The method of claim 2, wherein the first scene view and the second scene view comprise at least one of a left eye image and a right eye image.

5. The method of claim 1, wherein identifying the at least one object of interest from the plurality of objects in the multiview-based 3D scene comprises at least one of:
monitoring viewing direction data indicating a viewing direction of at least one eyeball viewing the 3D scene through the eyewear;
analyzing test audience viewing direction data indicating a viewing direction of a test audience when the test audience viewed the 3D scene;
evaluating each object's proximity from a center of the 3D scene; and
evaluating a size of each object in relation to a size of the 3D scene.

6. The method of claim 1, further comprising, in response to the provided focus adjustment control data, adjusting a focus of at least one lens in the eyewear to place the at least one object of interest in focus.

7. The method of claim 1, further comprising:
comparing pixels in a first scene view with pixels in a second scene view to identify which at least one object in the first scene view is the same at least one object in the second scene view to provide objection correlation data.

8. The method of claim 1, further comprising:
determining a perceived distance between the at least one object of interest and at least one other object; and
applying a level of blurring to each at least one other object, wherein the level of blurring is based on the perceived distance between the at least one object of interest and the at least one other object.

9. Circuitry comprising:
logic operative to:
identify at least one object of interest from a plurality of objects in a multiview-based 3D scene displayed on one or more displays; and
provide focus adjustment control data for eyewear to view the 3D scene based on perceived distance data corresponding to the identified at least one object of interest and the identified at least one object of interest.

10. The circuitry of claim 9, wherein the circuitry comprises perceived object distance determining logic operative to determine the perceived distance data corresponding to the at least one object of interest based on at least:
inter-object distance data indicating a horizontal offset between the at least one object of interest in a first scene view and the same at least one object of interest in a second scene view; and
display distance data indicating the distance between the one or more display screens and a viewing position.

11. The circuitry of claim 10, wherein the circuitry further comprises object correlation logic operative to compare pixels in a first scene view with pixels in a second scene view to identify which at least one object in the first scene view is the same at least one object in the second scene view to provide objection correlation data, and wherein the perceived object distance determining logic determines the perceived distance data corresponding to the at least one object of interest based on the object correlation data.

12. The circuitry of claim 9, wherein the circuitry comprises object of interest identification logic operative to identify the at least one object of interest from the plurality of objects in the multiview-based 3D scene by at least one of:
monitoring viewing direction data indicating a viewing direction of at least one eyeball viewing the 3D scene through the eyewear;
analyzing test audience viewing direction data indicating a viewing direction of a test audience when the test audience viewed the 3D scene;
evaluating each object's proximity from a center of the 3D scene; and
evaluating a size of each object in relation to a size of the 3D scene.

13. The circuitry of claim 9, wherein the circuitry comprises focus adjustment logic operative to provide focus adjustment control data for adjusting a focus of at least one lens in eyewear.

14. A system comprising:
an apparatus comprising circuitry operative to:
identify at least one object of interest from a plurality of objects in a multiview-based 3D scene;
provide focus adjustment control data for eyewear to view the 3D scene based on perceived distance data corresponding to the identified at least one object of interest and the identified at least one object of interest;
determine a perceived distance between the at least one object of interest and at least one other object; and
apply a level of blurring to each at least one other object, wherein the level of blurring is based on the perceived distance between the at least one object of interest and the at least one other object.

15. The system of claim 14, wherein the apparatus comprises one or more displays operative to output the multiview-based 3D scene and the system comprises eyewear operatively connected to the apparatus, the eyewear operative to adjust a focus of at least one lens in the eyewear in response to the provided focus adjustment control data.

16. The system of claim 15, wherein the eyewear comprises a range finder operative to provide display distance data indicating the distance between the one or more display screens and a viewing position.

17. The system of claim 14, wherein the circuitry comprises perceived object distance determining logic operative to determine the perceived distance data corresponding to the at least one object of interest based on at least:
inter-object distance data indicating a horizontal offset between the at least one object of interest in a first scene view and the same at least one object of interest in a second scene view; and
display distance data indicating the distance between the one or more display screens and a viewing position.

18. The system of claim 14, wherein the circuitry comprises object of interest identification logic operative to identify the at least one object of interest from the plurality of objects in the multiview-based 3D scene by at least one of:
monitoring viewing direction data indicating a viewing direction of at least one eyeball viewing the 3D scene through the eyewear;
analyzing test audience viewing direction data indicating a viewing direction of a test audience when the test audience viewed the 3D scene;
evaluating each object's proximity from a center of the 3D scene; and
evaluating a size of each object in relation to a size of the 3D scene.

19. Eyewear comprising:
an adaptive lens configuration operative to adjust a focus of at least one lens in the eyewear in response to receiving focus adjustment control data; and
a range finder comprising a transmitter and a receiver, the range finder operative to provide display distance data indicating the distance between one or more display screens and a position of the eyewear.

20. The eyewear of claim 19, further comprising:
a viewing direction detector operative to detect a viewing direction of at least one eyeball to provide viewing direction data.

21. A method comprising:
identifying at least one object of interest from a plurality of objects in a multiview-based 3D scene displayed on one or more displays; and
applying a level of blurring to at least one object that is different than the object of interest, wherein the level of blurring is based on a perceived distance between the at least one object of interest and the at least one object that is different than the object of interest.

22. The method of claim 21, wherein identifying the at least one object of interest from the plurality of objects in the multiview-based 3D scene comprises at least one of:
monitoring viewing direction data indicating a viewing direction of at least one eyeball viewing the 3D scene through eyewear;
analyzing test audience viewing direction data indicating a viewing direction of a test audience when the test audience viewed the 3D scene;
evaluating each object's proximity from a center of the 3D scene; and
evaluating a size of each object in relation to a size of the 3D scene.

23. The method of claim 21, further comprising:
comparing pixels in a first scene view with pixels in a second scene view to identify which at least one object in the first scene view is the same at least one object in the second scene view to provide objection correlation data.
